(19) United States
(12) Patent Application Publication
(10) Pub. No.: US 2026/0005280 A1
(43) Pub. Date: Jan. 1, 2026

(54) STACK STRUCTURE FOR AN ELECTROCHEMICAL ENERGY CONVERTER, AND METHOD FOR PRODUCING THE STACK STRUCTURE

(71) Applicant: Robert Bosch GmbH, Stuttgart (DE)

(72) Inventor: Peter Stahl, Metzingen (DE)

(21) Appl. No.: 18/879,291

(22) PCT Filed: Jun. 20, 2023
(86) PCT No.: PCT/EP2023/066571

§ 371 Date: Dec. 27, 2024

(30) Foreign Application Priority Data
Jun. 30, 2022 (DE) 10 2022 206 639.1

(51) Int. Cl. H01M 8/2483; H01M 4/86; H01M 8/0273; H01M 8/0286; H01M 8/242

(52) U.S. Cl. CPC H01M 8/2483; H01M 8/0273; H01M 8/0286; H01M 8/242; H01M 2004/8694; H01M 2250/20

(57) ABSTRACT

The present invention relates to a stack structure (10) for an electrochemical energy converter (80), comprising bipolar plates (11), membrane electrode units (12), a process fluid routing structure (13) for routing process fluid in a stacking direction (14), frame seals (15), which are respectively attached to the membrane electrode unit (12) in an edge region of a membrane electrode unit (12), process fluid seals (16) for sealing an edge area of the process fluid routing structure (13), wherein the process fluid seals (16) each comprise an inner seal portion (18), which, viewed in a transverse direction (19), is positioned between the process fluid routing structure (13) and the membrane electrode units (12), edge seals (17) for sealing an edge region of the frame seals (15) and/or an edge region of the bipolar plates (11), and spacer elements (20), positioned and/or configured in the stacking direction (14) between two inner seal portions (18) and each having a through-opening (21) for routing process fluid in the transverse direction (19) from the process fluid routing structure (13) to the respective membrane electrode unit (12). The invention further relates to a method of manufacturing such a stack structure (10).

### BACKGROUND

The present invention relates to a stack structure for an electrochemical energy converter, in particular to a fuel cell stack. The present invention further relates to a method of manufacturing such a stack structure.

An electrochemical energy converter in the form of a fuel cell stack consists of a plurality of substantially uniformly formed single cells, each constructed of a bipolar plate and a membrane electrode unit (MEA) that are assembled to form a stack. In each single cell, different media or process fluids, typically fuel, oxidizers and coolants, are conducted at different levels. The fuel cell stack is supplied with the process fluids via manifolds that run in the stacking direction or a corresponding process fluid routing structure; the fluids are then generally drained out of the process fluid routing structure once again via further manifolds. That is to say, the process fluid routing structure typically has channels for supplying process fluids to each fuel cell, as well as channels for draining process fluids from each fuel cell. In an active area, so-called flow fields ensure the most even distribution possible of the process fluids over the active surface of the single cells.

Bipolar plates may consist of two or more individual layers, which may be joined together in a material-locking manner by welding or gluing. A cooling medium, for example water, can be guided in cavities formed between two joined individual layers. A process fluid, such as hydrogen or air, can be guided on one side facing away from the second individual layer. There a membrane electrode units between each set of two bipolar plates, with each unit typically comprising a catalyst-coated membrane (CCM) and two gas diffusion layers (GDL). In addition, the membrane electrode unit may also comprise an additional reinforcing frame or a frame seal (subgasket) made of one or more film layers, which at least partially enclose the catalyst-coated membrane of the membrane electrode unit on its outer circumference.

The various media spaces of the fuel cell stack must be sealed against each other and against the surrounding environment. Various joining and/or sealing methods may be employed for this purpose, for example welding, gluing and applying metallic and/or elastomeric seals. For example, two layers of a bipolar plate can be sealed by welding, while the seal between a bipolar plate and a membrane electrode unit can be carried out with elastomeric seals. Elastomeric seals may be fastened on the bipolar plate, on a separate carrier, or on a component of the membrane electrode assembly, such as the frame seal or gas diffusion layer.

The joining and/or sealing lines intersect in a transition region into the flow field. Various possibilities for designing the media feedthroughs and sealing structures necessary for this purpose are known in the prior art.

DE 10 394 231 T5 describes that seal lines in the area of the media feedthroughs can be arranged orthogonally offset from the stacking direction so that media can be guided past the seals via openings in the bipolar plate. In the embodiment described therein, the bipolar plates must be designed asymmetrically and placed in a stacked process rotated by 180° to the adjacent bipolar plate around the stack axis. Patent applications US 2012/0164560 A1, US 2009/0197147 A1 and DE10 248 531 A1 describe that a bead seal supported by metal, if necessary in combination with an elastomeric seal applied to the bead, can be used to create gas spaces on the anode and cathode side opposite a subgasket or frame seal. The media feeds may be realized via openings in the beads, thereby requiring an outward sealing of a cavity between the two individual layers of a bipolar plate through which the process fluids flow.

DE 10 2014 104 017 A1 describes how the two layers of a bipolar plate in the area of the process fluid supply between manifolds or a process fluid routing structure and a respective flow field are designed spaced apart from one another. The process fluids may be routed in the resulting space between the two layers of the respective bipolar plate between the process fluid routing structure and the flow field. For process fluids that are routed within the active surface not between the two layers of a bipolar plate but on the outer side of a two-layer bipolar plate, openings may be provided within the seal line in one of the two layers of the bipolar plates so that a process fluid can flow from the area between the two layers of a bipolar plate into the anode-side or cathode-side flow field. The seal may be bonded to a gas diffusion layer or to a frame seal. According to this teaching, however, the variant of a connection of the seal to the bipolar plate in an injection molding process, which is advantageous from a manufacturing technical and functional point of view, is not possible or is possible only with a high level of effort, because the welded bipolar plate consisting of two layers does not offer any mechanical support in the area of the media feed for attaching a pressing edge of an injection molding tool. Injecting a seal onto a single layer is also not possible, because in the subsequent welding process the welding lines cross or overlap the seal lines, which would destroy the seal. Connecting the seal to the gas diffusion layer or to the frame seal results in increased requirements with regard to component handling, since these components have low (bending) stiffness.

In summary, it can therefore be determined that there are already many different approaches in the prior art for realizing the fluid connection between the process fluid routing structure and/or the manifolds and the flow field and/or the active area of the fuel cells, which have different advantages as well as disadvantages.

### SUMMARY

In the context of the present invention, a stack structure and a method for manufacturing the stack structure are now provided. In particular, a stacked structure according to the disclosure and a method of manufacturing the stacked structure according to the disclosure are proposed. Further embodiments of the invention arise from the description and the figures. In this context, features described in connection with the stack structure also of course apply in connection with the method according to the invention, and vice versa, so that, with respect to the disclosure, mutual reference to the individual aspects of the invention is and/or can always be made.

According to a first aspect of the present invention, a stack structure for an electrochemical energy converter is proposed, comprising:
bipolar plates,
membrane electrode units,
a process fluid routing structure for routing process fluid in a stacking direction,
frame seals, each of which is fixed to the membrane electrode unit in an edge region of a membrane electrode unit, wherein the bipolar plates and the frame seals are arranged one above the other in the stacking direction,
process fluid seals for sealing an edge region of the process fluid guide structure, wherein the process fluid seals each have an inner seal portion positioned between the process fluid routing structure and the membrane electrode units that each, viewed in a transverse direction, run orthogonal to the stacking direction from the process fluid seals towards the membrane electrode units,
edge seals for sealing an edge region of the frame seals and/or an edge region of the bipolar plates, and
spacer elements, each positioned and/or configured in the stacking direction between two inner seal portions and each having an opening for routing process fluid in the transverse direction from the process fluid routing structure to the respective membrane electrode unit.

In order to take into account the problems mentioned in the introduction to the description, it is proposed to design the stack structure with the spacer elements according to the invention. Process fluid seals and/or process fluid sealing portions can be positioned on each of the spacer elements for this purpose; as compared to process fluid seals or process fluid sealing portions, these are not directly positioned on a spacer element, and are configured with a thickness that is reduced in the stacking direction. Through the spacer elements or through-openings, the process fluid can be reliably transported in each case between the process fluid routing structure and the membrane electrode unit or an active area of a respective fuel cell.

Another advantage of the invention is that, due to the spacer elements, all individual positions of the bipolar plates in the distribution or transition region between the process fluid routing structure and the active area are level with one another or can be configured accordingly. This allows the individual layers to be simply welded together. In a subsequent process step, each process fluid seal including the inner seal portion can be bonded to the previously welded bipolar plate, for example in the form of injection molding. Pressing edges for an injection molding tool can be mounted or supported in a stable manner. In addition, the process fluid seal may be manufactured in only a single process step. In the aforementioned prior art, two process steps are generally required for this purpose.

Through the use of injection molding, gaskets can be produced quickly and easily shaped. Thus, the required assembly forces of the respective process fluid seal as well as the functional and/or tolerance range of the respective process fluid seal that can be covered can be increased in the stacking direction as compared to previous solutions, thereby further achieving a relatively favorable mechanical construction of the overall cell. This applies in particular to the process fluid supply of gases, i.e. oxidizing agents in the form of air and fuel in the form of hydrogen, for example. For coolants, which are usually routed between individual layers of a bipolar plate, a slightly different but generally similar construction may be selected.

Each of the spacer elements may be part of one of the cell components, that is, part of a functional component of the stack structure. Nevertheless, the spacer elements may also be provided as standalone functional components. Each process fluid seal may comprise a transition section in the transition or distribution area, in which the thickness or height of the respective process fluid seal in the stacking direction varies from a maximum height to a reduced height in the transition region. The respective spacer element may also have a corresponding thickness variation such that a relative compression of the process fluid seal in the transition region is substantially in a similar range.

The spacer element may be thus pronounced in the stacking direction orthogonal to the middle level in one direction or both directions with reference to a middle level of the membrane electrode unit running along the transverse direction. The spacer elements may be made of plastic and/or metal. Furthermore, it is possible that spacer elements are configured in pairs, i.e., mechanically connected to each other with each pair as a unit. Thus, a spacer unit may comprise two mechanically connected spacer elements, wherein the one spacer element comprises a through-opening for routing a first process fluid in the transverse direction from the process fluid routing structure to the respective membrane electrode unit, and the other spacer element comprises a further through-opening for routing a second process fluid different from the first process fluid in the transverse direction from the process fluid routing structure to the respective membrane electrode unit. The mechanical connection between the two spacer elements may be completed by a bar connection, in particular by a plate and/or film-shaped bar connection. By mechanically joining two or more spacer elements, the manufacturing and handling of the spacer elements can be simplified and tolerances can be minimized in the stack structure.

The process fluid seals are preferably each annular in shape. Frame seals are each referred to as sub-gaskets. Because the bipolar plates and frame seals can be disposed one above the other in the stacking direction, it may be understood that the bipolar plates and frame seals are disposed at least partially and/or in portions above one another. Furthermore, it is possible that further functional components are disposed between the bipolar plates and the frame seals. That is, the bipolar plates and frame seals need not be disposed directly one above the other. Preferably, the process fluid seals and the edge seals are each positioned between the bipolar plates and the frame seals in the stacking direction.

The electrochemical energy converter can be understood as an electrolyzer, a fuel cell system, in particular a PEM fuel cell system, and/or a fuel cell stack. A bipolar plate can be understood to be a one-piece or a multi-piece bipolar plate, i.e. a bipolar plate with, for example, two plate elements or individual layers positioned on one another. A bipolar plate can also be understood as only the single layer. Accordingly, the bipolar plates can each comprise a cathode-sided single layer and an anode-sided single layer, or be configured as one. The frame seals are preferably each connected to the membrane electrode units in a material-locking manner. In principle, the invention also relates to a stack structure with only one spacer element, an edge seal, a frame seal and/or a membrane electrode unit.

According to a further embodiment of the present invention, it is possible for the frame seals to each comprise two frame seal layers in a stack structure, wherein the spacer elements are each positioned between two frame seal layers in the stacking direction. The spacer elements can thus be made of two frame seal layers or single foil layers introduced between the two frame seal layers during manufacturing of the frame seals. The inserted spacer elements may be bonded to one of the frame seal layers in a material-locking manner or may be inserted as a separate part between the frame seal layers during the assembly process of the stack structure. The spacer element and its attachment to the frame sealing layers may be executed such that one of the two frame sealing layers is arranged to be continuous in the transition region, while the other frame sealing layer has a recess in the transition area in which the spacer element is at least partially positioned. Accordingly, the spacer element may protrude in the stacking direction beyond the area of the recess.

Alternatively or additionally, it is possible for spacer elements to be positioned at different locations in the stack structure directly between a frame seal and an inner seal portion in the stacking direction in a stack structure according to the present invention. In this case, the spacer elements may be considered a substitute for conventional sub-tunneled sealing portions. The desired through-opening for routing the process fluids in the transition region may be provided simply and reliably using the spacer elements. The spacer elements may each be clamped, or positioned in a pressurized manner, between a frame seal and an inner seal portion. Preferably, the spacer elements are each attached to the frame seal in a material-locking fashion.

According to a further design variant of the invention, it is possible that each of the spacer elements are respectively designed as an integral and/or monolithic component of a frame seal. That is, each spacer element may be a part of one of the frame seals and/or frame seal layers. Thus, the spacer elements can be provided in a particularly stable manner in the stack structure. Further, the manufacturing process of the stack structure can thus be simplified.

Furthermore, it is possible for each of the spacer elements in a stack structure according to the invention to comprise a support structure for a support function in the stacking direction, wherein the support structure forms at least two through-opening channels extending parallel to each other in the through-opening or in a corresponding through-opening volume. Accordingly, each of the spacer elements may have a support structure such that, upon loading of the stack structure by mounting forces and/or forces during operation of the stack structure, there are no or only minor deformations in the stacking direction. The support structure may have a V-shaped, W-shaped, wedge-shaped, corrugated and/or bar-shaped cross section.

In addition, with a stack structure according to the invention, it is possible for bipolar plates to be welded together by means of at least one weld seam, wherein at least one weld seam in the stacking direction is configured between two process fluid seals and/or between two inner seal portion of the process fluid seals. That is to say, in a stack structure according to the present invention, weld lines and seal lines may overlay or cross one another, thereby enabling a compact design of the entire stack structure. In addition, weld lines can thus be at least partially protected against contact with reaction media, in particular coolant, by covering them with seal material and thus, for example, be protected against corrosion.

Another aspect of the present invention relates to a method of manufacturing a stack structure for an electrochemical energy converter. The method comprises the following steps:
providing bipolar plates,
providing membrane electrode units,
providing a process fluid routing structure for routing process fluid in a stacking direction,
providing frame seals, each of which is secured to the membrane electrode unit in an edge region of a membrane electrode unit, wherein the bipolar plates and the frame seals are each disposed one above the other in the stacking direction,
providing process fluid seals for sealing an edge region of the process fluid routing structure, wherein the process fluid seals each comprise an inner seal portion which, viewed in a transverse direction that runs orthogonal to the stacking direction from the process fluid seals towards the membrane electrode units, is positioned between the process fluid routing structure and the membrane electrode units,
providing edge seals for sealing an edge region of the frame seals and/or an edge region of the bipolar plates, and
positioning and/or configuring spacer elements in the stacking direction, respectively, between two inner seal portions for forming through-openings configured to route process fluid in the transverse direction from the process fluid routing structure to the respective membrane electrode unit.

The method according to the invention thus has the same advantages as those described in detail with reference to the stack structure according to the invention. The spacer elements may be made of plastic and/or metal. The spacer elements may each be manufactured by injection molding, embossing, forming, deep drawing, gluing, welding, and/or cutting. Accordingly, in a method according to the invention, it is possible for spacer elements to each be injected onto a frame seal as an injection molding component. Thus, the spacer elements can be manufactured quickly and easily.

In a method according to the present invention, the spacer elements can also be produced by plastic, in particular by thermoplastic forming of a frame seal. This allows a particularly space-saving and logistically easy-to-implement stack structure to be realized.

According to a further design variant of the present invention, it is possible that in one method, the frame seals each comprise two frame seal layers and the spacer elements are inserted as an inserted component between two frame seal layers. A relatively simple assembly process can also be provided therewith, through which the spacer element according to the invention can be positioned securely and robustly at the desired location.

### BRIEF DESCRIPTION OF THE DRAWINGS

Further measures that improve the invention are shown in the following description of various exemplary embodiments of the invention, which are shown schematically in the figures. All features and/or advantages resulting from the claims, the description, or the figures, including design details and spatial arrangements, can be essential to the invention both individually and in the various combinations.

Schematically shown are:

FIG. 1 a top plan view of a stack structure according to a preferred embodiment of the present invention,

FIG. 2 a sectional view of the stack structure according to the invention,

FIG. 3 a further sectional view of the stack structure according to the invention,

FIG. 4 a further sectional view of the stack structure according to the invention,

FIG. 5 a top plan view of a partial section of a stack structure according to the invention,

FIG. 6 a further sectional view of a stack structure according to the invention,

FIG. 7 a further sectional view of a stack structure according to the invention,

FIG. 8 a vehicle having a stack structure according to the present invention, and

FIG. 9 a flow chart to explain a method according to the invention.

### DETAILED DESCRIPTION

Elements having the same function and mode of action are in each case provided with the same reference signs in the figures.

FIG. 1 shows a top plan view of a stack structure 10 for an electrochemical energy converter 80 in the form of a PEM fuel cell stack. The stack structure 10 comprises metal bipolar plates 11, membrane electrode units 12 and a process fluid routing structure 13 having a plurality of manifolds and fluid channels in a stacking direction 14. More specifically, the stack structure 10 comprises a process fluid routing structure 13 having two oxidizer channels 31, two coolant channels 32 and two fuel channels 33, wherein in each case only one of the two channel portions in fluid communication with each other is shown. The membrane electrode unit 12 shown comprises a catalyst coated membrane (CCM) 24 positioned between two gas diffusion layers (GDL) 23.

The stack structure 10 shown further comprises a manifold or transition region 67, in which a distribution channel structure 64 is configured to route the respective process fluid between the process fluid routing structure 13 and the manifolds and the membrane electrode unit 12 and an active area 60 of the respective fuel cells, respectively. The active area 60 may also be understood as the so-called flowfield. Oxidant supply lines 36, coolant supply lines 37, and coolant ports 38 are configured in the transition region. The stack structure 10 shown also has welded seams 34 at various locations. In addition, the stack structure 10 comprises process fluid seals 16 and edge seals 17, which will be described in further detail with reference to the following figures. The process fluid seals 16 consisting of an elastomer are each configured annularly around the channels running parallel to one another in the stacking direction i.e., around the respective oxidizer channel 31, the respective coolant channel 32 and the respective fuel channel 33.

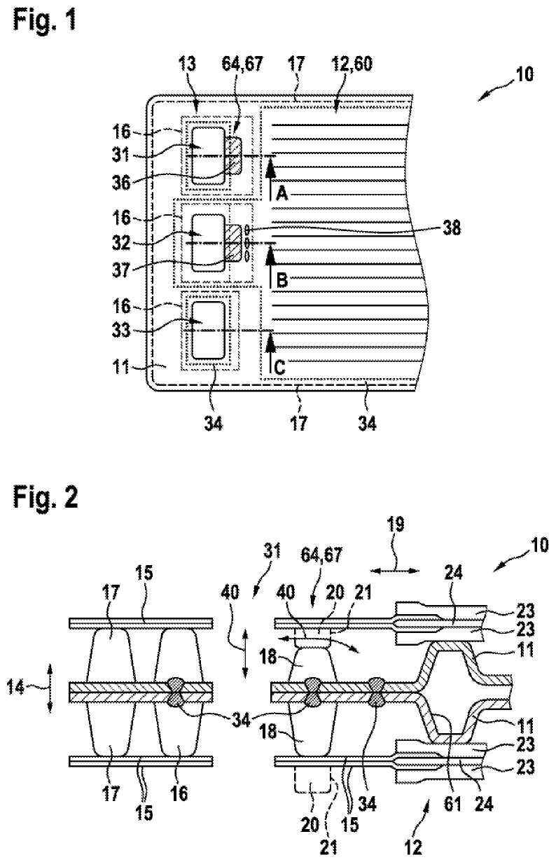

FIG. 2 shows a cross-sectional view according to the section A-A shown in FIG. 1 extending through an oxidizer channel 31 of the stack structure 10. That is, in the oxidizer channel 31 shown, there is a process fluid flow 40 with oxidizer in the form of air. As shown in FIG. 2, the stack structure 10 comprises frame seals 15 or subgaskets, each of which is mounted in an edge region of a membrane electrode unit 12 to the membrane electrode unit 12, more specifically, each of which is mounted between the catalyst membrane 24 and a gas diffusion layer 23, extending in a frame-like manner around the membrane electrode unit 12. As further shown in FIG. 2, the bipolar plates 11 and the individual bipolar plate layers, respectively, as well as the frame seals 15 are disposed one above the other in the stacking direction 14. The frame seals 15 each have two frame seal layers. The two individual layers of the bipolar plates 11 are level with one another in the area of the process fluid seal 16 as well as in the area of the edge seal 17. The process fluid seals 16 are manufactured and bonded in an injection molding process simultaneously on either side of the respective bipolar plates 11.

The process fluid seals 16 shown are designed and configured to seal an edge region of the process fluid routing structure 13, wherein the process fluid seal 16 has an inner seal portion 18 which, when viewed in a transverse direction 19, that is orthogonal to the stacking direction 14 and runs from the process fluid seals 16, respectively, towards the membrane electrode units 12, is positioned between the process fluid guide structure 13 and the membrane electrode units 12. The edge seals 17 are designed and configured to seal an edge region of the frame seals 15 as well as an edge region of the bipolar plates 11. Further shown in FIG. 2 are spacer elements 20 of the stack structure 10, each configured in the stacking direction 14 between two inner seal portions 18 and each having a through-opening 21 for routing process fluid in the transverse direction 19 between the process fluid routing structure 13 and the respective membrane electrode unit 12 or the active area 60, respectively. The spacer elements 20 are each positioned directly between a frame seal 15 and an inner seal portion 18 in the stacking direction 14. In the inner seal portions 18, each of the process fluid seals 16 is configured with a reduced height in the stacking direction 14 to create space for the respective spacer element. Each of the spacer elements 20 has a rounded outer contour so that damage by the spacer elements 20 to the frame seal 15 is prevented as far as possible.

The bipolar plates 11 and the respective bipolar plate layers are welded together in pairs. Thus, the respective bipolar plates 11 have welded seams 34 at various locations. As can be seen in FIG. 2, a weld seam 34 of a welded bipolar plate 11 in the stacking direction 14 is respectively configured between two inner seal portions 18 of the process fluid seals 16 directly above one another. Another weld seam 34 is configured at a different location between two other portions of two process fluid seals 16.

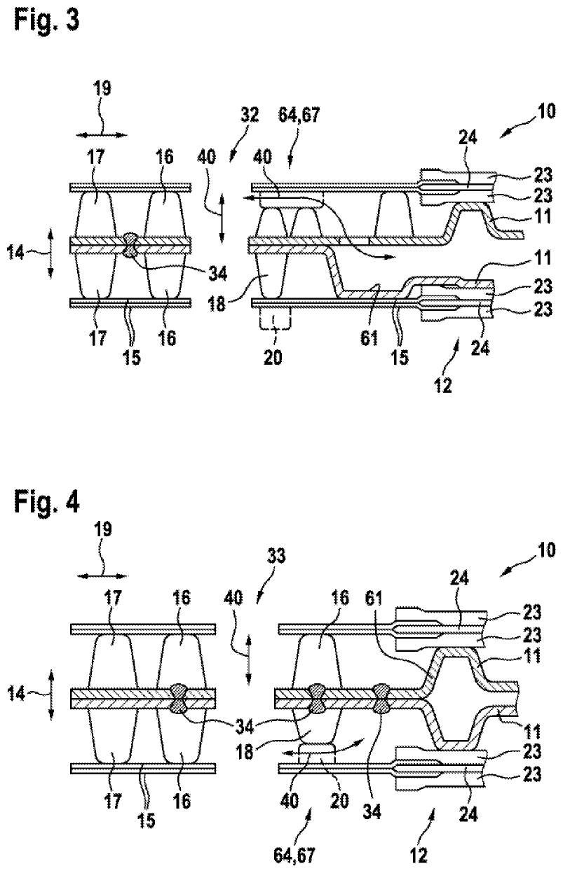

FIG. 3 shows a cross-sectional view according to section B-B shown in FIG. 1 extending through the coolant channel 32 of the stack structure 10. That is, in the coolant channel 32 shown and in the adjacent spacer elements 20 there is a respective process fluid flow 40 with coolant. FIG. 4 shows a cross-sectional view according to section C-C shown in FIG. 1 extending through the fuel channel 33 of the stack structure 10. That is, in the fuel channel 33 shown and in the adjacent spacer elements 20 there is a respective process fluid flow 40 with fuel in the form of hydrogen. Depending on whether the spacer elements 20 or at least one spacer element 20 is provided for routing oxidizer, coolant, or fuel, it may have different shape contours and/or material components in detail, for example, for realizing a necessary sealing function. That is to say, the spacer elements 20 shown in the present case need not all have the same shape and/or material nature.

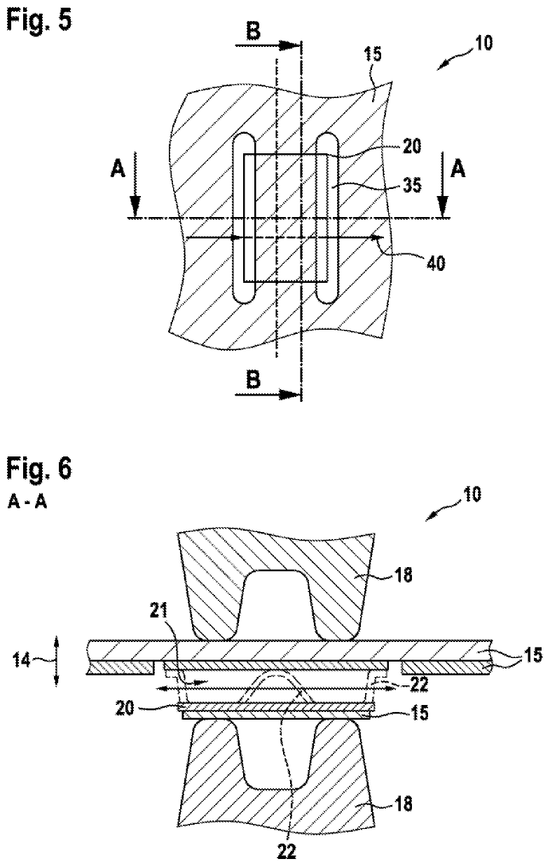

FIG. 5 shows a top plan view of a partial section of a stack structure 10 according to the invention. FIG. 6 shows a sectional view along the section A-A. shown in FIG. 5. FIG. 6 shows an embodiment in which the spacer element 20 has a support structure 22 for a support function in the stacking direction 14. The support structure 22 is substantially W-shaped and thereby forms three through-opening channels that extend parallel to each other in the through-opening 21.

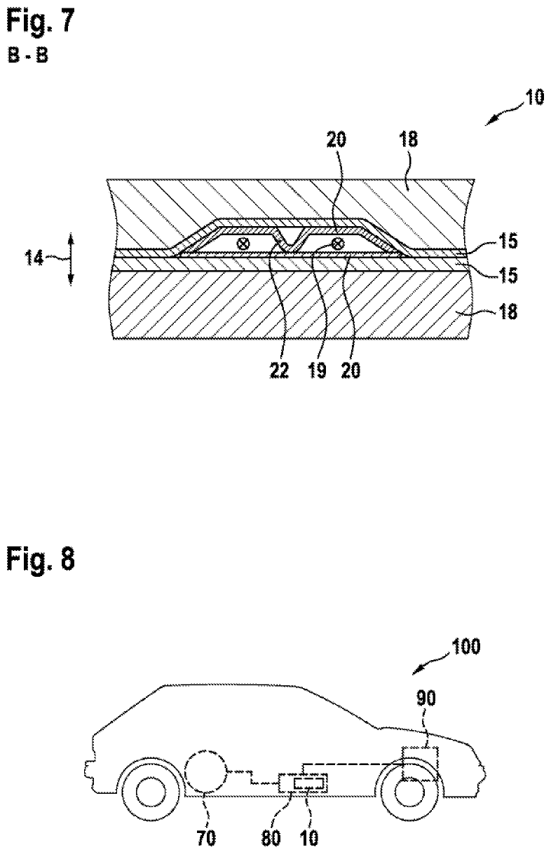

FIG. 7 shows a cross-sectional view according to the section B-B shown in FIG. 5. As can be seen particularly clearly in FIG. 7, the spacer element 20 shown is positioned according to this embodiment in the stacking direction 14 between two frame sealing layers 15.

FIG. 8 shows a vehicle 100 having an electrochemical energy converter 80 in the form of a fuel cell system having a stacked structure 10 described above. The vehicle 100 further comprises a fuel tank 70 and an engine 90, wherein the energy converter 80 is configured to generate power for the engine 90 from the fuel in the fuel tank 70. The engine 90 is configured to propel the vehicle 100.

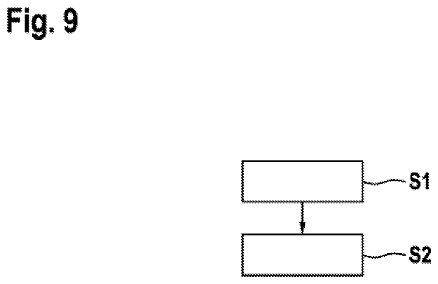

FIG. 9 illustrates a flow chart for explaining a method of manufacturing a stack structure 10 for an electrochemical energy converter 80 described above. In a first step S1, the bipolar plates 11, the membrane electrode units 12, the process fluid routing structure 13, the frame seals 15, and the process fluid seals 16 each having the inner seal portion 18 and the edge seals 17 are provided or configured. In a second step S2, the spacer elements 20 are each positioned and/or formed in the stacking direction 14 between two inner seal portions 18 to form through-openings 21 configured to route process fluid in the transverse direction 19 from the process fluid routing structure 13 to the respective membrane electrode unit 12.

The second step S2 need not be performed after the first step S1. Depending on the nature and/or method of manufacture of the spacer elements 20, they may be formed at different times in the manufacturing process. Each of the spacer elements 20 can be injected onto a frame seal 15 as an injection molded plastic component, for example. In this case, for example, the process fluid seals 16 are not configured until after the spacer elements 20 are manufactured and/or provided in the stack structure 10. Further, it is possible that the spacer elements 20 are each produced by plastically forming a frame seal 15. Also in this case, the process fluid seals 16 are not used until after the spacer elements 20 are manufactured or provided in the stack structure 10. Moreover, it is possible for spacer elements 20 to be inserted as an inserted component between two frame seal layers. Again, in this case, the process fluid seals 16 are not configured until after the spacer elements 20 have been manufactured in the stack structure 10.

The invention allows for further design principles in addition to the illustrated embodiments. That is to say, the invention is not intended to be limited to the exemplary embodiments explained with reference to the figures. Thus, the spacer elements 20 may each be configured as an integral and/or monolithic component of a frame seal 15. The spacer elements 20 may further be pressed into one or more individual layers of the respective frame seal 15 by a thermal process so that a homogeneous transition between spacer element 20 and frame seal 15 may be created.

1. A stack structure (10) for an electrochemical energy converter (80), comprising:
bipolar plates (11),
membrane electrode units (12),
a process fluid routing structure (13) for routing process fluid in a stacking direction (14),
frame seals (15), each attached to the membrane electrode unit (12) in an edge region of the membrane electrode unit (12), wherein the bipolar plates (11) and the frame seals (15) are arranged one above the other in the stacking direction (14),
process fluid seals (16) for sealing an edge region of the process fluid routing structure (13), wherein each of the process fluid seals (16) comprises an inner seal portion (18) that, viewed in a transverse direction (19) that runs orthogonal to the stacking direction (14) and to the membrane electrode units (12) from the process fluid seals (16), is positioned between the process fluid routing structure (13) and the membrane electrode units (12),
edge seals (17) for sealing an edge region of the frame seals (15) and/or an edge region of the bipolar plates (11),
wherein
spacer elements (20) that are each positioned and/or configured between two inner seal portions (18) in the stacking direction (14) and that each have a through-opening (21) for routing process fluid in the transverse direction (19) from the process fluid routing structure (13) comprise the respective membrane electrode unit (12).

2. The stack structure (10) of claim 1,
wherein
the frame seals (15) each comprise two frame seal layers, wherein spacer elements (20) are positioned between two frame seal layers (15), in the stacking direction (14) in each case.

3. The stack structure (10) according to claim 1,
wherein
spacer elements (20) are positioned directly between a frame seal (15) and an inner seal portion (18) in the stacking direction (14).

4. The stack structure (10) according to claim 1,
wherein
spacer elements (20) are each configured as an integral and/or monolithic component of a frame seal (15).

5. The stack structure (10) according to claim 1,
wherein
the spacer element (20) comprises a support structure (22) for a support function in the stacking direction (14), wherein the support structure (22) forms at least two through-opening channels extending parallel to each other in the through-opening (21).

6. The stack structure (10) according to claim 1,
wherein
the bipolar plates (11) are welded together by at least one weld seam (34), wherein at least one weld seam (34) in the stacking direction (14) is formed between two process fluid seals (16) and/or between two inner seal portions (18) of the process fluid seals (16).

7. A method of manufacturing a stack structure (10) for an electrochemical energy converter (80), the method comprising:
providing bipolar plates (11),
providing membrane electrode units (12),
providing a process fluid routing structure (13) for routing process fluid in a stacking direction (14),
providing frame seals (15) each secured to the membrane electrode unit (12) in an edge region of the membrane electrode unit (12), wherein the bipolar plates (11) and the frame seals (15) are each disposed above one another in the stacking direction (14),
providing process fluid seals (16) for sealing an edge region of the process fluid routing structure (13), wherein the process fluid seals (16) each have an inner seal portion (18) which, viewed in a transverse direction (19) orthogonal to the stacking direction (14) and running from the process fluid seals (16) respectively towards the membrane electrode units (12), is positioned between the process fluid routing structure (13) and the membrane fluid electrode units (12),
providing edge seals (17) for sealing an edge region of the frame seals (15) and/or an edge region of the bipolar plates (11), and
positioning and/or configuring spacer elements (20) in the stacking direction (14) between two inner seal portions (18) in each case to form through-openings (21) configured to route process fluid in the transverse direction (19) from the process fluid routing structure (13) to the respective membrane electrode unit (12).

8. The method according to claim 7,
wherein
spacer elements (20) are each injected as an injection molded component onto a frame seal (15).

9. The method according to claim 7,
wherein
spacer elements (20) are each manufactured by plastically forming a frame seal (15).

10. The method according to claim 7,
wherein
frame seals (15) each comprise two frame seal layers and the spacer elements (20) are inserted as an inserted component between the two frame seal layers.
